(19) United States
(12) Patent Application Publication
(10) Pub. No.: US 2026/0176850 A1
(43) Pub. Date: Jun. 25, 2026

(54) FAUCET

(71) Applicant: Xiamen Lota International Co., Ltd., Xiamen (CN)

(72) Inventors: Chenglong Lin, Xiamen (CN); Yicong Lai, Xiamen (CN); Yanyan Wang, Xiamen (CN); Qiang Huang, Xiamen (CN); Chuanbao Zhu, Xiamen (CN)

(21) Appl. No.: 19/247,016

(22) Filed: Jun. 24, 2025

(30) Foreign Application Priority Data
Dec. 20, 2024 (CN) 202423167003.2

(51) Int. Cl. E03C 1/04; E03C 1/02; F16K 11/00

(52) U.S. Cl. CPC E03C 1/0403; F16K 19/006; E03C 2001/026

(57) ABSTRACT

A faucet includes a faucet body and a waterway structure. A valve assembly includes a first valve outlet port and a second valve outlet port, and the valve assembly is configured to control a turning on and off of the second valve outlet port. The waterway structure includes a valve seat, a water inlet pipe assembly, a water outlet pipe, and an electromagnetic valve. The water inlet pipe assembly includes a first water inlet pipe, a second water inlet pipe, and a water inlet connector respectively connected to the first water inlet pipe and the second water inlet pipe. The valve seat, the water inlet connector, and the water outlet pipe form a first water inlet path and a second water inlet path, and the electromagnetic valve is configured to control a turning on and off of the first water inlet path.

### RELATED APPLICATIONS

This application claims priority to Chinese patent application number 202423167003.2, filed on Dec. 20, 2024. Chinese patent application number 202423167003.2 is incorporated herein by reference.

### FIELD OF THE DISCLOSURE

The present disclosure relates to a faucet.

### BACKGROUND OF THE DISCLOSURE

As an essential water-use device in daily life, the structural and functional design of a faucet directly impacts user experience and convenience. Traditional faucets generally comprise two main components: a faucet body and a valve assembly. The faucet body is typically installed on a countertop to provide a stable water outlet head, while the valve assembly, located inside or near the faucet body, controls the on/off operation, flow rate, and temperature of the water. Most existing faucet valve assemblies on the market adopt a “two-inlet, two-outlet” design. Specifically, there are two inlets (connected to cold and hot water pipes, respectively) and two outlets. One outlet delivers mixed water directly to the faucet spout for regular use, while the other outlet is typically connected to an electromagnetic valve (solenoid valve), which then routes water to the water outlet head via an additional water outlet pipe.

However, while this two-inlet, two-outlet design enhances functionality to some extent, it also introduces issues. For example, the requirement for multiple inlet/outlet pipes and wiring to control the solenoid valve complicates internal routing and piping, leading to difficulties in installation and maintenance.

### BRIEF SUMMARY OF THE DISCLOSURE

The technical problem to be solved by the present disclosure is to provide a faucet with simplified pipelines.

In order to solve the above technical problems, the present disclosure provides a faucet comprising a faucet body and a waterway structure.

The faucet body comprises a valve assembly, and the valve assembly is configured to receive hot water and cold water to form mixed water. The valve assembly is configured to control a mixing ratio of the hot water and the cold water to control a temperature of the mixed water. The valve assembly comprises a first valve outlet port and a second valve outlet port, and the first valve outlet port and the second valve outlet port are respectively connected to the mixed water. The valve assembly is configured to control a turning on and off of the second valve outlet port.

The waterway structure comprises a valve seat, a water inlet pipe assembly, a water outlet pipe, and an electromagnetic valve. The valve seat comprises a water inlet port and a water outlet port, and the water inlet pipe assembly comprises a first water inlet pipe, a second water inlet pipe, and a water inlet connector. The first water inlet pipe and the second water inlet pipe are respectively connected to the water inlet connector. The first water inlet pipe is connected to the first valve outlet port, and the second water inlet pipe is connected to the second valve outlet port. The water inlet connector is detachably connected to the water inlet port. A first end of the water outlet pipe is detachably connected to the water outlet port, and a second end of the water outlet pipe is connected to a water outlet head of the faucet body. The electromagnetic valve is connected to the valve seat, and the valve seat, the water inlet connector, and the water outlet pipe form a first water inlet path and a second water inlet path. The first water inlet path is sequentially in communication with the first water inlet pipe, the electromagnetic valve, and the water outlet pipe. The second water inlet path is in communication with the second water inlet pipe and the water outlet pipe, and the electromagnetic valve is configured to control a turning on and off of the first water inlet path.

In a preferred embodiment, the faucet further comprises a sensing member. The sensing member is disposed on the faucet body, and the sensing member is connected to the electromagnetic valve to control the electromagnetic valve.

In a preferred embodiment, the faucet further comprises a battery box, and the battery box is respectively connected to the electromagnetic valve and the sensing member.

In a preferred embodiment, a first flow channel and a second flow channel are formed in the water inlet port. The first flow channel and the second flow channel are respectively connected to the first water inlet pipe and the second water inlet pipe, and a first water outlet channel and a second water outlet channel are formed in the water outlet port. The first flow channel and the first water outlet channel are respectively connected to the electromagnetic valve, and the first water outlet channel and the second water outlet channel are configured to be respectively connected to the water outlet pipe.

In a preferred embodiment, the water inlet connector comprises a first water inlet channel connected to the first water inlet pipe and a second water inlet channel connected to the second water inlet pipe, and the first water inlet channel and the second water inlet channel are respectively inserted into the first flow channel and the second flow channel.

In a preferred embodiment, a check valve is disposed in the first water outlet channel.

In a preferred embodiment, an outer side of the water inlet connector comprises a buckling groove, and the water inlet port is disposed with a buckling ring configured to be buckled to the buckling groove.

In a preferred embodiment, the water inlet connector comprises a first portion and a second portion. The first portion and the second portion are arranged on the first water inlet pipe and the second water inlet pipe at intervals, and the buckling groove is formed between the first portion and the second portion.

In a preferred embodiment, the valve seat comprises a valve seat body and a converging connector. The converging connector comprises a first converging channel, a second converging channel, and an outlet channel. The converging connector is connected to the valve seat body so that the first converging channel and the second converging channel are respectively connected to the first water outlet channel and the second water outlet channel. The outlet channel is respectively connected to the first converging channel and the second converging channel, and the first end of the water outlet pipe is detachably connected to the converging connector to be connected to the outlet channel.

Compared with the existing techniques, the technical solution has the following advantages.

The waterway structure comprises the valve seat, the water inlet pipe assembly, the water outlet pipe, and the electromagnetic valve. The valve seat comprises the water inlet port and the water outlet port, and the water inlet pipe assembly comprises the first water inlet pipe, the second water inlet pipe, and the water inlet connector. The first water inlet pipe and the second water inlet pipe are respectively connected to the water inlet connector. The first water inlet pipe is connected to the first valve outlet port, and the second water inlet pipe is connected to the second valve outlet port. The water inlet connector is detachably connected to the water inlet port. The first end of the water outlet pipe is detachably connected to the water outlet port, and the second end of the water outlet pipe is connected to the water outlet head of the faucet body. The electromagnetic valve is connected to the valve seat, and the valve seat, the water inlet connector, and the water outlet pipe form a first water inlet path and a second water inlet path. The first water inlet path is sequentially in communication with the first water inlet pipe, the electromagnetic valve, and the water outlet pipe. The second water inlet path is in communication with the second water inlet pipe and the water outlet pipe, and the electromagnetic valve is configured to control the turning on and off of the first water inlet path.

The first water inlet pipe and the second water inlet pipe are connected as an integrated unit to the valve seat via a water inlet connector, reducing a number of the pipelines and simplifying the pipelines.

### BRIEF DESCRIPTION OF THE DRAWINGS

FIG. 1 is a perspective view of a faucet in the preferred embodiment of the present disclosure.

FIG. 2 is a cross-sectional view of the faucet in the preferred embodiment of the present disclosure.

FIG. 3 is a perspective view of an electromagnetic valve, a sensing member, and battery box in the preferred embodiment of the present disclosure.

FIG. 4 is a perspective schematic view of a water inlet pipe assembly and a valve seat in the preferred embodiment of the present disclosure.

FIG. 5 is a perspective view of a buckling ring in the preferred embodiment of the present disclosure.

FIG. 6 is a cross-sectional view of a waterway structure in the preferred embodiment of the present disclosure.

FIG. 7 is a cross-sectional view of the waterway structure in the preferred embodiment of the present disclosure.

### DETAILED DESCRIPTION OF THE EMBODIMENTS

The present disclosure is further described below in conjunction with the accompanying drawings and specific embodiments.

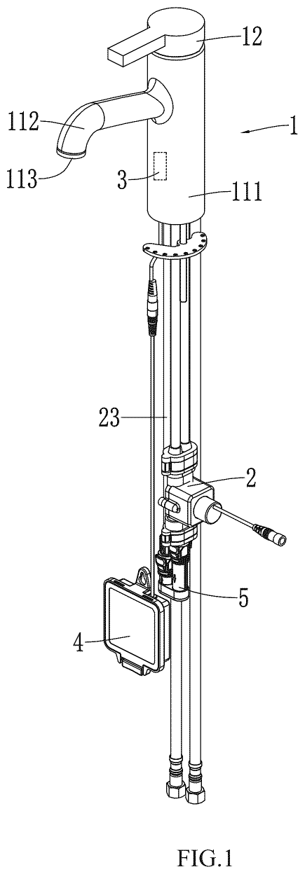

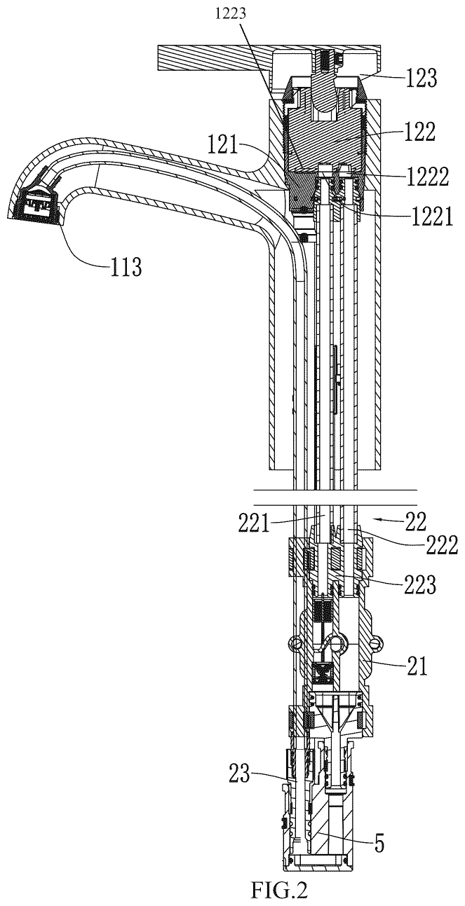

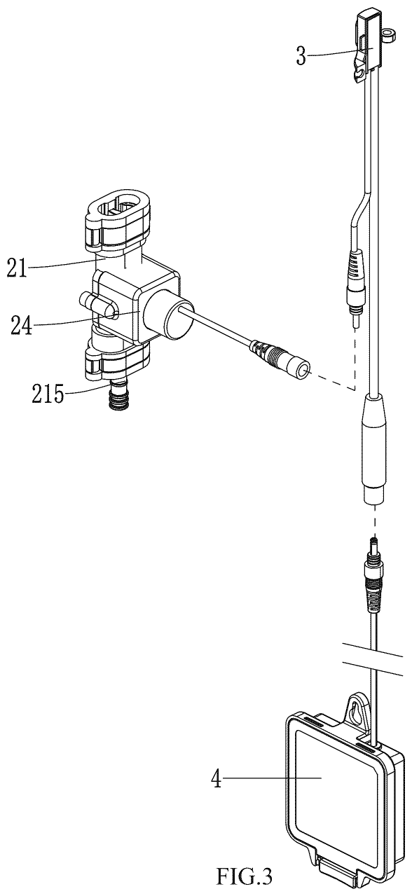

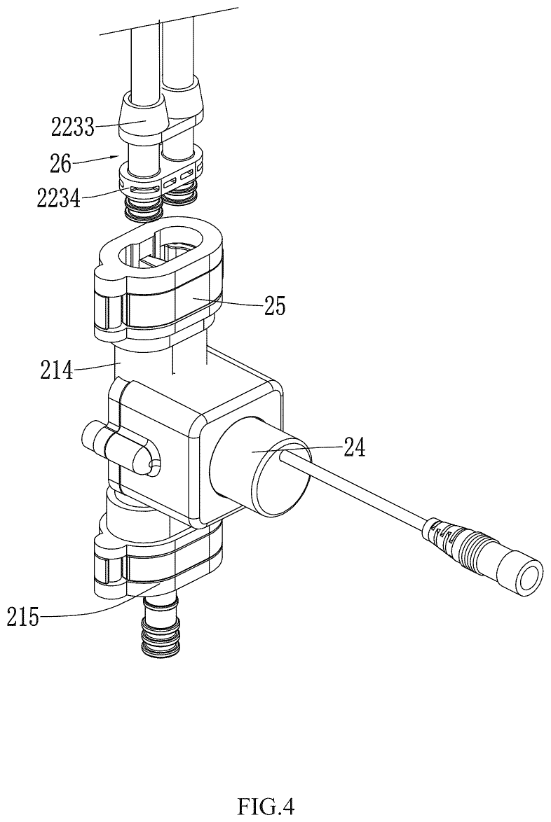

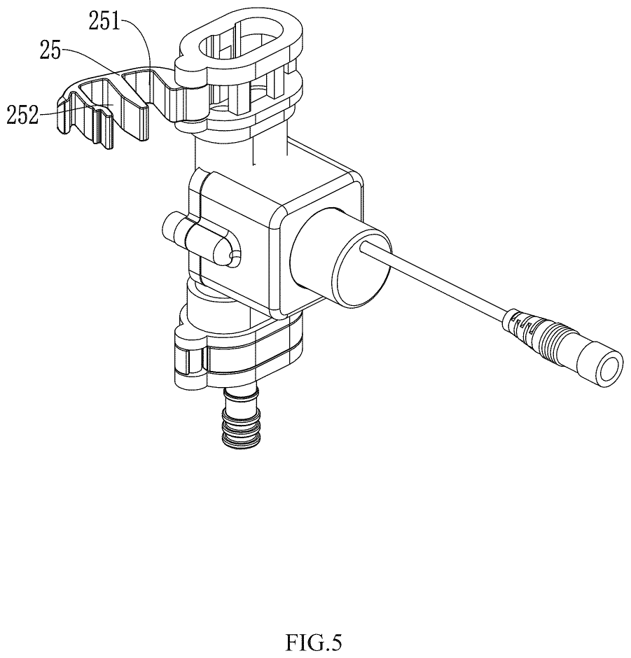

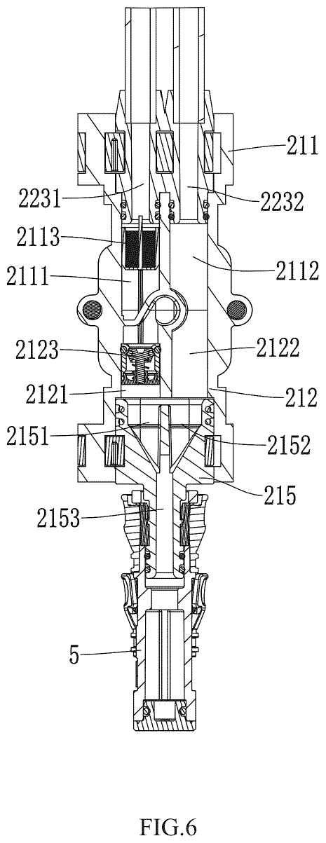

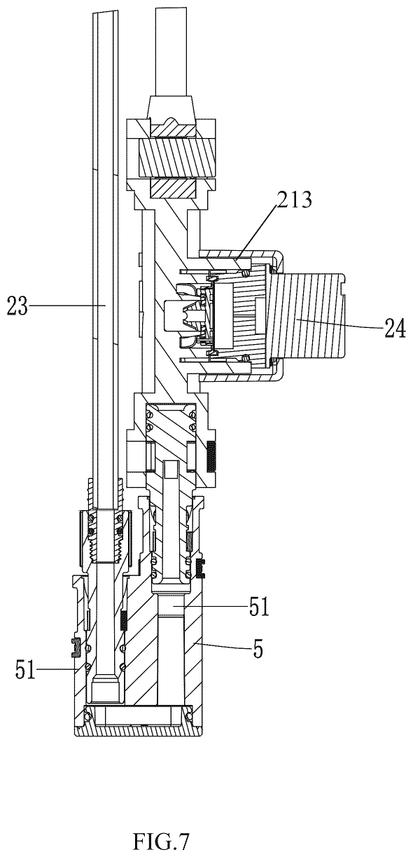

Referring to FIGS. 1 to 7, a faucet is shown, and the faucet comprises a faucet body 1 and a waterway structure 2.

The faucet body 1 comprises a faucet housing and a valve assembly 12. The faucet housing comprises a vertical housing 111 and a lateral housing 112 connected to the vertical housing 111. A water outlet head 113 is disposed at a distal end of the lateral housing 112, and the water outlet head 113 is an aerator.

The valve assembly 12 is disposed at an upper end of the vertical housing 111. The valve assembly 12 comprises a valve core seat 121, a valve core 122, and a handle assembly 123. The valve core seat 121 is fixedly connected to the upper end of the vertical housing 111. The valve core 122 is disposed in the valve core seat 121. The handle assembly 123 is connected to the valve core 122 so as to control the valve core 122. The valve core 122 has two inlet ports 1223 and two outlet ports (i.e., a first valve outlet port 1221 and a second valve outlet port 1222). The valve core 122 is configured to receive hot water and cold water to form mixed water. The valve core 122 can control a mixing ratio of the hot water and the cold water to control a temperature of the mixed water. The valve core 122 comprises the first valve outlet port 1221 and the second valve outlet port 1222. The first valve outlet port 1221 and the second valve outlet port 1222 are respectively connected to the mixed water. The valve assembly 12 is configured to control a turning on and off of the second valve outlet port 1222. The first valve outlet port 1221 is always connected to the mixed water.

The waterway structure 2 comprises a valve seat 21, a water inlet pipe assembly 22, a water outlet pipe 23, and an electromagnetic valve 24. The valve seat 21 comprises a water inlet port 211, a water outlet port 212, and a mounting port 213. The water inlet pipe assembly 22 comprises a first water inlet pipe 221, a second water inlet pipe 222, and a water inlet connector 223, and the first water inlet pipe 221 and the second water inlet pipe 222 are respectively connected to the water inlet connector 223. The first water inlet pipe 221 is connected to the first valve outlet port 1221, and the second water inlet pipe 222 is connected to the second valve outlet port 1222. The water inlet connector 223 is detachably connected to the water inlet port 211. A first end of the water outlet pipe 23 is detachably connected to the water outlet port 212, and a second end of the water outlet pipe 23 is connected to the water outlet head 113 of the faucet body 1. The electromagnetic valve 24 is connected to the mounting port 213 of the valve seat 21. The valve seat 21, the water inlet connector 223, and the water outlet pipe 23 form a first water inlet path and a second water inlet path. The first water inlet path is sequentially in communication with the first water inlet pipe 221, the electromagnetic valve 24, and the water outlet pipe 23, and the second water inlet path is in communication with the second water inlet pipe 222 and the water outlet pipe 23. The electromagnetic valve 24 is configured to control a turning on and off of the first water inlet path.

The faucet further includes a sensing member 3. The sensing member 3 is disposed on the faucet body 1, and the sensing member 3 is connected to the electromagnetic valve 24 to control the electromagnetic valve 24. In this embodiment, the sensing member 3 is disposed on the faucet housing. The sensing member 3 can sense presence of a hand to control a turning on and off of the electromagnetic valve 24. The faucet further comprises a battery box 4, and the battery box 4 is respectively connected to the electromagnetic valve 24 and the sensing member 3.

For the waterway structure 2, a first flow channel 2111 and a second flow channel 2112 are formed in the water inlet port 211, and the first flow channel 2111 and the second flow channel 2112 are respectively connected to the first water inlet pipe 221 and the second water inlet pipe 222. A first water outlet channel 2121 and a second water outlet channel 2122 are formed in the water outlet port 212, and the first flow channel 2111 and the first water outlet channel 2121 are respectively connected to the mounting port 213. The electromagnetic valve 24 is disposed on the mounting port 213 to be respectively connected to the first flow channel 2111 and the first water outlet channel 2121. The first water outlet channel 2121 and the second water outlet channel 2122 are configured to be respectively connected to the water outlet pipe 23. The water inlet connector 223 comprises a first water inlet channel 2231 connected to the first water inlet pipe 221 and a second water inlet channel 2232 connected to the second water inlet pipe 222. The first water inlet channel 2231 and the second water inlet channel 2232 are respectively inserted into the first flow channel 2111 and the second flow channel 2112.

A check valve 2123 is disposed in the first water outlet channel 2121, and a filter 2113 is disposed in the first flow channel 2111. The filter 2113 can prevent impurities from entering the electromagnetic valve 24 and causing damage to the electromagnetic valve 24. The check valve 2123 can prevent water from flowing back to the electromagnetic valve 24 when the first water outlet channel 2121 discharges water.

In this embodiment, an outer side of the water inlet connector 223 comprises a buckling groove 26, and the water inlet port 211 is disposed with a buckling ring 25 configured to be buckled to the buckling groove 26. Specifically, the water inlet connector 223 comprises a first portion 2233 and a second portion 2234, and each of the first portion 2233 and the second portion 2234 is arranged on the first water inlet pipe 221 and the second water inlet pipe 222 at intervals. The buckling groove 26 is formed between the first portion 2233 and the second portion 2234. The buckling ring 25 comprises a first buckling portion 251 and a second buckling portion 252, and the buckling ring 25 is rotatably connected to the valve seat 21. The first buckling portion 251 can be correspondingly buckled to the first water inlet pipe 221 located in the buckling groove 26, and the second buckling portion 252 can be correspondingly buckled to the second water inlet pipe 222 located in the buckling groove 26.

The valve seat 21 comprises a valve seat body 214 and a converging connector 215. The converging connector 215 comprises a first converging channel 2151, a second converging channel 2152 and an outlet channel 2153, and the converging connector 215 is connected to the valve seat body 214 so that the first converging channel 2151 and the second converging channel 2152 are respectively connected to the first water outlet channel 2121 and the second water outlet channel 2122. The outlet channel 2153 is respectively connected to the first converging channel 2151 and the second converging channel 2152, and the first end of the water outlet pipe 23 is detachably connected to the converging connector 215 to be connected to the outlet channel 2153.

The faucet further comprises a water outlet connector 5, and the water outlet connector 5 is detachably connected to the converging connector 215 and the water outlet pipe 23. The water outlet connector 5 is U-shaped and comprises two openings 51. The first end of the water outlet pipe 23 is detachably buckled to one of the two openings 51 of the water outlet connector 5, and a distal end of the converging connector 215 is detachably buckled to the other one of the two openings 51 of the water outlet connector 5.

The above is only a preferred, specific implementation method of the present disclosure, but the design concept of the present disclosure is not limited to this. Any technician familiar with the technical field who uses this concept to make non-substantial changes to the present disclosure within the technical scope disclosed by the present disclosure shall be deemed to infringe the protection scope of the present disclosure.

What is claimed is:

1. A faucet, comprising:
a faucet body, and
a waterway structure, wherein:
the faucet body comprises a valve assembly,
the valve assembly is configured to receive hot water and cold water to form mixed water,
the valve assembly is configured to control a mixing ratio of the hot water and the cold water to control a temperature of the mixed water,
the valve assembly comprises a first valve outlet port and a second valve outlet port,
the first valve outlet port and the second valve outlet port are respectively connected to the mixed water,
the valve assembly is configured to control a turning on and off of the second valve outlet port,
the waterway structure comprises a valve seat, a water inlet pipe assembly, a water outlet pipe, and an electromagnetic valve,
the valve seat comprises a water inlet port and a water outlet port,
the water inlet pipe assembly comprises a first water inlet pipe, a second water inlet pipe, and a water inlet connector,
the first water inlet pipe and the second water inlet pipe are respectively connected to the water inlet connector,
the first water inlet pipe is connected to the first valve outlet port,
the second water inlet pipe is connected to the second valve outlet port,
the water inlet connector is detachably connected to the water inlet port,
a first end of the water outlet pipe is detachably connected to the water outlet port,
a second end of the water outlet pipe is connected to a water outlet head of the faucet body,
the electromagnetic valve is connected to the valve seat,
the valve seat, the water inlet connector, and the water outlet pipe form a first water inlet path and a second water inlet path,
the first water inlet path is sequentially in communication with the first water inlet pipe, the electromagnetic valve, and the water outlet pipe,
the second water inlet path is in communication with the second water inlet pipe and the water outlet pipe, and
the electromagnetic valve is configured to control a turning on and off of the first water inlet path.

2. The faucet according to claim 1, wherein:
the faucet further comprises a sensing member,
the sensing member is disposed on the faucet body, and
the sensing member is connected to the electromagnetic valve to control the electromagnetic valve.

3. The faucet according to claim 2, wherein:
the faucet further comprises a battery box, and
the battery box is respectively connected to the electromagnetic valve and the sensing member.

4. The faucet according to claim 1, wherein:
a first flow channel and a second flow channel are formed in the water inlet port,
the first flow channel and the second flow channel are respectively connected to the first water inlet pipe and the second water inlet pipe,
a first water outlet channel and a second water outlet channel are formed in the water outlet port,
the first flow channel and the first water outlet channel are respectively connected to the electromagnetic valve, and
the first water outlet channel and the second water outlet channel are configured to be respectively connected to the water outlet pipe.

5. The faucet according to claim 4, wherein:
the water inlet connector comprises a first water inlet channel connected to the first water inlet pipe and a second water inlet channel connected to the second water inlet pipe, and
the first water inlet channel and the second water inlet channel are respectively inserted into the first flow channel and the second flow channel.

6. The faucet according to claim 4, wherein:
a check valve is disposed in the first water outlet channel.

7. The faucet according to claim 1, wherein:
an outer side of the water inlet connector comprises a buckling groove, and
the water inlet port is disposed with a buckling ring configured to be buckled to the buckling groove.

8. The faucet according to claim 7, wherein:
the water inlet connector comprises a first portion and a second portion,
each of the first portion and the second portion is arranged on the first water inlet pipe and the second water inlet pipe at intervals, and
the buckling groove is formed between the first portion and the second portion.

9. The faucet according to claim 4, wherein:
the valve seat comprises a valve seat body and a converging connector,
the converging connector comprises a first converging channel, a second converging channel, and an outlet channel,
the converging connector is connected to the valve seat body so that the first converging channel and the second converging channel are respectively connected to the first water outlet channel and the second water outlet channel,
the outlet channel is respectively connected to the first converging channel and the second converging channel, and
the first end of the water outlet pipe is detachably connected to the converging connector to be connected to the outlet channel.
